(19) United States
(12) Patent Application Publication
(10) Pub. No.: US 2002/0103733 A1
(43) Pub. Date: Aug. 1, 2002

(54) Process, system and financial planning engine for determining at least one financial indicator for use in achieving a particular financial goal

(75) Inventors: Richard Barrington, Macedon, NY (US); Christopher J. Cummings, Rochester, NY (US); Jeffrey S. Coons, Rochester, NY (US)

Correspondence Address: BAKER & BOTTS, 30 ROCKEFELLER PLAZA, NEW YORK, NY, 10112

(73) Assignee: MANNING & NAPIER ADVISORS, INC.

(21) Appl. No.: 09/734,746

(22) Filed: Dec. 12, 2000

(51) Int. Cl. G06F 17/60

(52) U.S. Cl. 705/35

(57) ABSTRACT

A process, system and financial planning engine which determine at least one financial indicator for investments and savings to achieve a particular goal. In particular, financial information is obtained from an investor, and further information is also obtained. This further information is indicative of the investor's tolerance for a decline in the investments and/or the investor's tolerance for failure to achieve the particular goal. Then, the financial indicator is determined as a function of the financial information and the further information. Using these process, system and financial planning engine, it is possible to determine asset allocations, return assumptions and annual savings needed to fund the investor's goals. The annual savings can be determined using the determined return assumptions.

### FIELD OF THE INVENTION

The present invention relates to a system, process and financial planning engine for determining at least one financial indicator (such as one's asset allocation requirements or savings information) to achieve a particular financial goal. In particular, the system, process and financial planning engine determine the financial data for at least one particular user based on data previously entered by or stored for such user. The system and process are also capable of determining return assumptions for the user.

### BACKGROUND INFORMATION

Generally, retirement planning calculators provide estimates of a lump sum and/or an annuity stream that are projected at one's retirement. This information is based on user's personal financial data, personal characteristics, expected retirement date, and estimated life expectancy. All these values are provided by a user (i.e., either inputted by the user or retrieved from a storage device for such user). The personal financial data may include account balances, current holdings, tax rates, etc., and the personal characteristics may be age, marital status or region of residence.

These calculators are intended to assist the users (e.g., the investors or participants in retirement plans) to identify savings rates and possible investment strategies that are best suited for their future investment and savings needs. However, conventional planning calculators utilize software engines and algorithms which have varying degrees of difficulty and sophistication so as to generate projected lump sum amounts or annuity streams for the users. In addition, the prior retirement planning calculators determine the necessary savings rates or asset allocation strategies required to achieve the above-mentioned projected lump sum amounts or annuity streams.

Indeed, the conventional planning calculator rely heavily on the information entered by the user. However, the requested information may not easily be identified or understood by the user. Particularly, most prior art retirement planning calculators require the user to enter his or her return expectations for the investments, as well as the user's asset allocation. These values are then used to determine the estimated future lump sum amount at the user's estimated retirement, and subsequently the annuity stream for the user which is estimated over the user's life expectancy.

Because the conventional retirement planning calculators rely heavily on the return assumptions of the retirement savings plans (the values which are extremely difficult to calculate even by the financial professionals), the informational value provided thereby is limited. In particular, these calculators use ad hoc assumptions regarding the future returns of the user to establish a set of input questions. These questions force the user to estimate the requested figures even though they may be irrelevant or inaccurate as indicators for calculating the user's future return for his or her investments.

Accordingly, there is a need to provide a system and process for determining estimated asset allocation requirements and future returns of the user in a more accurate manner. For example, instead of using solely the information provided by the user, this determination can be made using other parameters and/or calculations which are described herein below.

### SUMMARY OF THE INVENTION

According to the present invention, a process, system and financial planning engine are provided which determine at least one financial indicator for investments and savings to achieve a particular goal. In particular, financial information is obtained from a user (e.g., an investor), and further information is also obtained. This further information is indicative of the investor's tolerance for a decline in the investments and/or the investor's tolerance for failure to achieve the particular goal. Then, a financial indicator is determined as a function of the financial information and the further information. Such financial indicators include one's asset allocations, proper return assumptions and appropriate annual savings needed to achieve the investor's goals. The annual savings can be determined using the determined return assumptions.

In another embodiment of the present invention, the financial indicator includes one's asset allocations, proper return assumptions and appropriate annual savings needed to achieve the investor's goals based on the financial information. Historical data may also be obtained for the investor or for at least one further party, and the asset allocation data may be calculated using such historical data. The financial indicator may include return assumption data for the investor.

In yet another embodiment of the present invention, the financial indicator may include annual savings data for the investor. The savings data may be composed of first data indicative of a lump sum needed for a retirement of the investor, second data indicative of a value of current savings at the retirement of the investor, third data indicative of total savings needed to close a gap for the investor between the first data and the second data, and/or fourth data indicative of annual savings needed to close the gap.

A further embodiment of the present invention provides that the financial information includes the current income of the investor, expected years until retirement of the investor, expected years to be spent in retirement, target annual retirement income of the investor, estimated annual social security benefits of the investor, and/or current retirement assets of the investor. In addition, the financial indicator may include return assumption data for the investor and lump sum data for the retirement of the investor. The lump sum data can be calculated based on the estimated annual social security benefits, expected years to be spent in the retirement, and return assumption data.

Another embodiment of the present invention provides that the financial indicator includes return assumption data for the investor and the current value of savings data at the retirement of the investor. The current value of savings data can be calculated based on the current retirement assets of the investor, the expected years until the retirement of the investor, and the return assumption data.

In yet another embodiment of the present invention, the financial indicator includes the return assumption data for the investor and the annual current saving data needed for the retirement of the investor. The current savings data can be calculated based on the current value of savings data, the expected years until the retirement of the investor, and the return assumption data.

According to a further embodiment of the present invention, it can be determined if the financial indicator is acceptable. Thus, if the financial indicator is not acceptable, additional financial information is received which includes at least one portion that is different from at least one portion of the previously obtained financial information. Thereafter, the financial indicator is determined as a function of the received additional financial information and the further information.

The system and process according to the present invention also provides an interactive retirement engine designed to aid the users of a retirement plan (e.g., 401K plan) and other investors to determine the amounts to save to further their retirement goals. One of the advantages of this engine is that it does not require the user (e.g., the participant or the investor) to estimate his or her expected returns on the investments, nor to make any assumption regarding such returns. Indeed, the above-described retirement calculator engine according to the present invention focuses on the user's risk profile, and can calculate a return-on-investment assumption based on historical data that is relevant to the user in light of his or her willingness to accept volatility and chances of success.

One of the advantages of the system, process and financial planning engine according to the present invention is that they utilize the potential uncertainty of the retirement planning, and provide a feedback loop if the user's expectations are possibly unreasonable or overzealous.

### BRIEF DESCRIPTION OF THE DRAWINGS

Exemplary embodiments of the present invention will now be described in detail with reference to the accompanying drawings in which:

FIG. 1 shows an exemplary embodiment of a system according to the present invention which provides a determination of asset allocation requirements and savings information for at least one user.

FIG. 2 shows an exemplary embodiment of a process according the present invention which determines asset allocation requirements and savings information for the user or users, and which is executable by the system illustrated in FIG. 1.

FIG. 3 shows an illustration of exemplary queries that can be provided to the user or users.

FIG. 4 shows exemplary information relating to annual savings for the user or users according to the present invention.

FIG. 5 shows another embodiment of the process according to the present invention which allows the user to view the results provided by the embodiment illustrated in FIG. 2, and modify the user's responses to the queries illustrated in FIG. 3.

FIG. 6 shows an exemplary chart utilized by the system, process and financial planning engine according to the present invention to determine the user's asset allocation assumption.

FIG. 7 shows an exemplary chart utilized by the system, process and financial planning engine according to the present invention to determine the user's return assumption.

### DETAILED DESCRIPTION

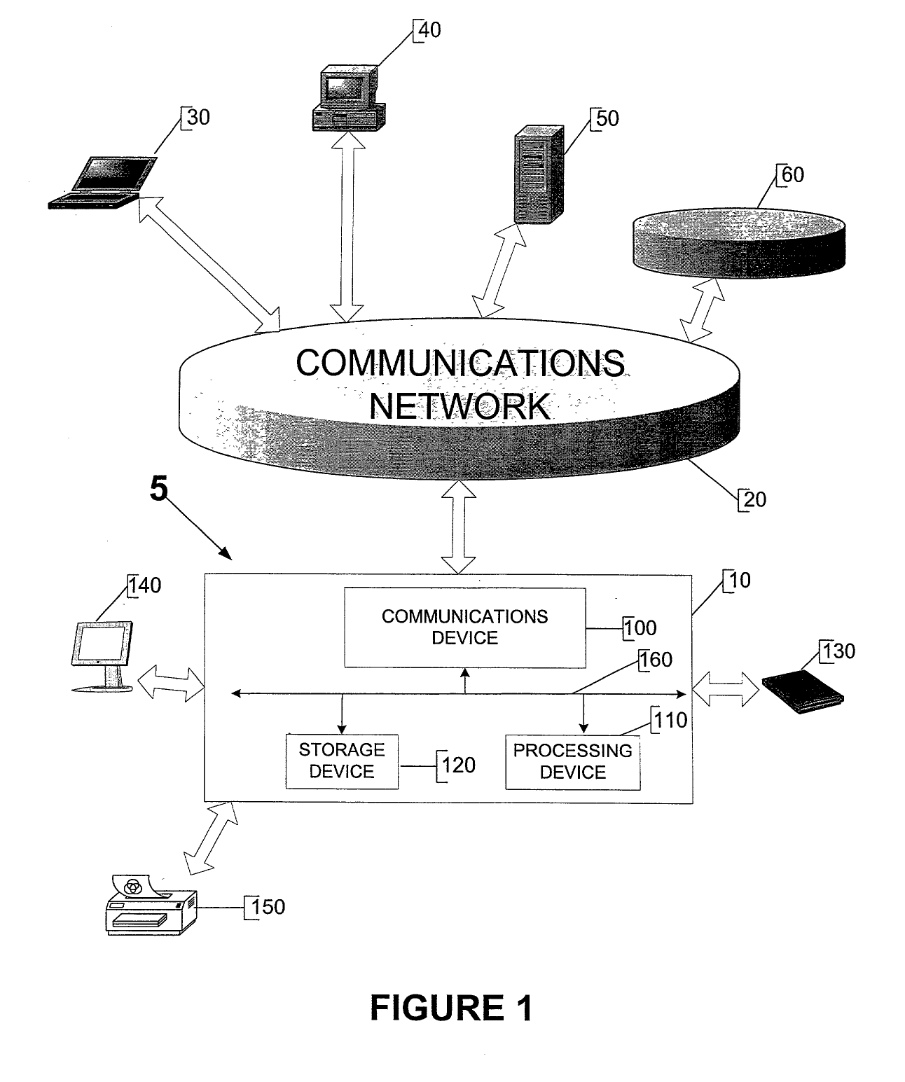

FIG. 1 shows an exemplary embodiment of a system 5 according to the present invention which provides a determination of asset allocation requirements and savings information for at least one user. The system 5 includes an arrangement 10 which is connected (e.g., via a wired connection or a wireless connection) to a communications network 20. In this exemplary embodiment of the system 5, the arrangement 10 includes a communications device 100, a processing device 110 and a storage device 120. The storage device 120 may be a hard drive, a Read-Only-Memory (“ROM”) device, a Read-Access-Memory (“RAM”) device, a laser disk storage device, etc. The communications device 100 may be a network card, a modem, etc. The processing device 110 may be a general purpose microprocessor (e.g., an Intel® Pentium® processor) or a special purpose processor. The communications device 100, the processing device 110 and the storage device 120 communicate with one another via a bus 160 provided in the arrangement 10, using, e.g., a two-way communication scheme. The arrangement 10 can be a multi-purpose computer (e.g., a server, laptop computer, a notebook computer, etc.) or a portable computing device (e.g., a hand-held computing device).

The arrangement 10 utilizes the communications device 100 to connect to the communications network 20. The processing device 110 is connected (via the bus 160) to the communications device 100 for receiving data from and transfer the data to the communications network 20. Generally, various user computing devices may be connected to the communications network 20. For example, these user devices may be a laptop computer 30, a personal computer 40, a personal digital assistant device (e.g. a PalmPilot®) and/or to other devices (e.g., a conventional telephone). These user devices communicate with the arrangement 10 via the communications network 20 to provide certain information to, and received data from the arrangement 10 regarding user's personal finances. After receiving this information from the user devices, the arrangement 10 may store this information in the storage device 120, and then utilize the stored information to generate particular data, such as asset allocation requirements, return assumptions and savings information for at least one user so as to avail it to such user. Thus, based on the personal information provided from one or more of the user devices 30, 40, 50, the arrangement 10 generates the asset allocation requirements, return assumptions and savings information for the user.

In one embodiment of the present invention, the personal information for a particular user is requested by the arrangement 10 from at least one database 60 via the communications network 20. This personal information may also be received by the arrangement 10 from a data retrieving device 130 that can be connected (either directly, via the communications network 20 or by other communications means) to the arrangement 10. The data retrieving device 130 may be a CD-ROM drive which reads a CD-ROM disks having the user's personal information thereon, a tape reading device which reads the user's person information from a data tape, a Zip drive, etc. In another embodiment of the system according to the present invention, the arrangement 10 can be connected to a display device 140 and/or a printing device 150. The display device 140 may be directed, by the arrangement 10, to display the information received from the user and/or the data generated by the arrangement 10 based on the user's information. The printing device 150 may also be directed by the arrangement 10 to print the data/information described above.

As shall be described in further detail below, the user may connect to the arrangement 10 (i.e., from the user device and via the communications network 20) to obtain particular information for assisting the user with his or her investments, such as 401K plan contributions and other investment information. Upon the connection with the user device (e.g., at least one of the devices 30, 40, 50), the arrangement 10 may transmit a request to the user device to receive the particular information from the user (e.g., financially-related information, demographic information, retirement planning information, etc.). This request may prompt certain questions to be displayed to the user at the user device. Some of these questions may be, e.g.:

Question A: “What is your current income?”

Question B: “How much of the retirement-type savings to you currently have?”

Question C: “In how may years do you plan to retire?”

Question D: “How many years do you plan to stay in retirement?”

Question E: “How much money, per year, do you plan to spend while in retirement?”

Question F: “How much Social Security annual income you expect to receive during your retirement?”

In addition, the system according to the present invention preferably requests the following information from the user:

Question G: “What is your tolerance for a decline in your investments or assets (%)?”, and

Question H: “What is your historical probability of success in your investments (%)?”

Then, the user enters some or all of the information in response to one or more of these questions, and the entered information is transmitted from the user device to the arrangement 10 via the communications network 20 and the communications device 100.

Thereafter, the arrangement 10 may store the received information in the storage device 120 (either temporarily or permanently), and executes the process according to the present invention using the processing device 110. For example, the processing device 110 may either retrieve the information received from the user device (e.g., entered by the user) from the storage device 120, or directly access the user-entered data received at the communications device 100 via the bus 160. Upon its receipt and/or retrieval of the user-entered data, the processing device 110 generates the asset allocation requirements, return assumptions, savings information and/or other information for the user based on the user-entered information received by the arrangement 10.

In one embodiment of the present invention, the arrangement 10 utilizes the data/information entered by the user for Question G to determine the asset allocation for the user, which is then used (preferably along with the data entered by the user for Question H) to determine the assumed return rate for the user. Thereafter, the arrangement 10 may utilize the determined assumed return rate for the user, possibly with other data entered by the user (e.g., the data entered for one or more of Questions A through F), to determine the annual savings for the particular user who requested such information. The determined data can then be transmitted via the communications network 20 to the user device of the user, recorded in the database 60, stored in the storage device 120 of the arrangement 10, and/or output on the display device 140 or the printing device 150. In this manner, the user (e.g., the participant of a retirement plan) and/or other investors/parties can determine the savings amounts for the user to further his or her retirement goals without requiring the user to make any assumptions regarding such returns. Indeed, the data requested from the user relate to the user's tolerance for the decline in investments, and the user's historical probability of success on his or her investments.

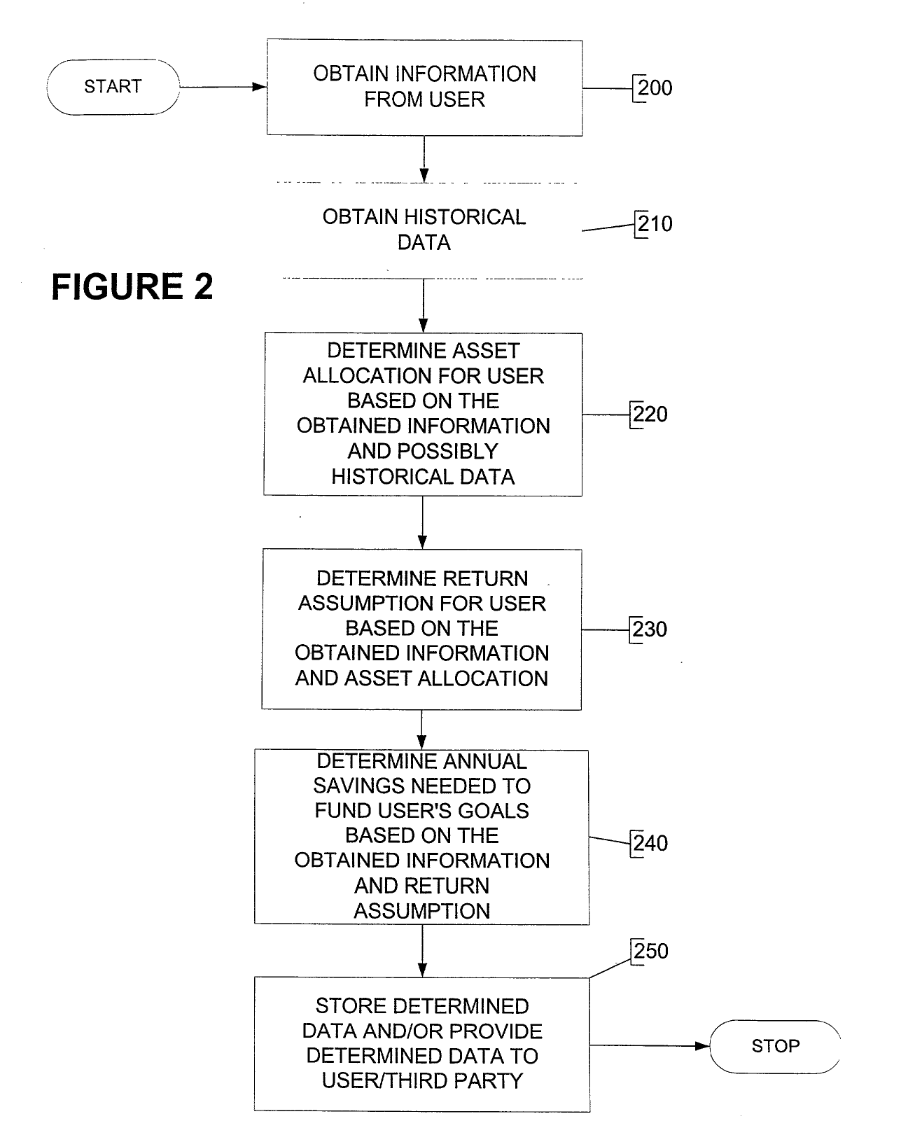

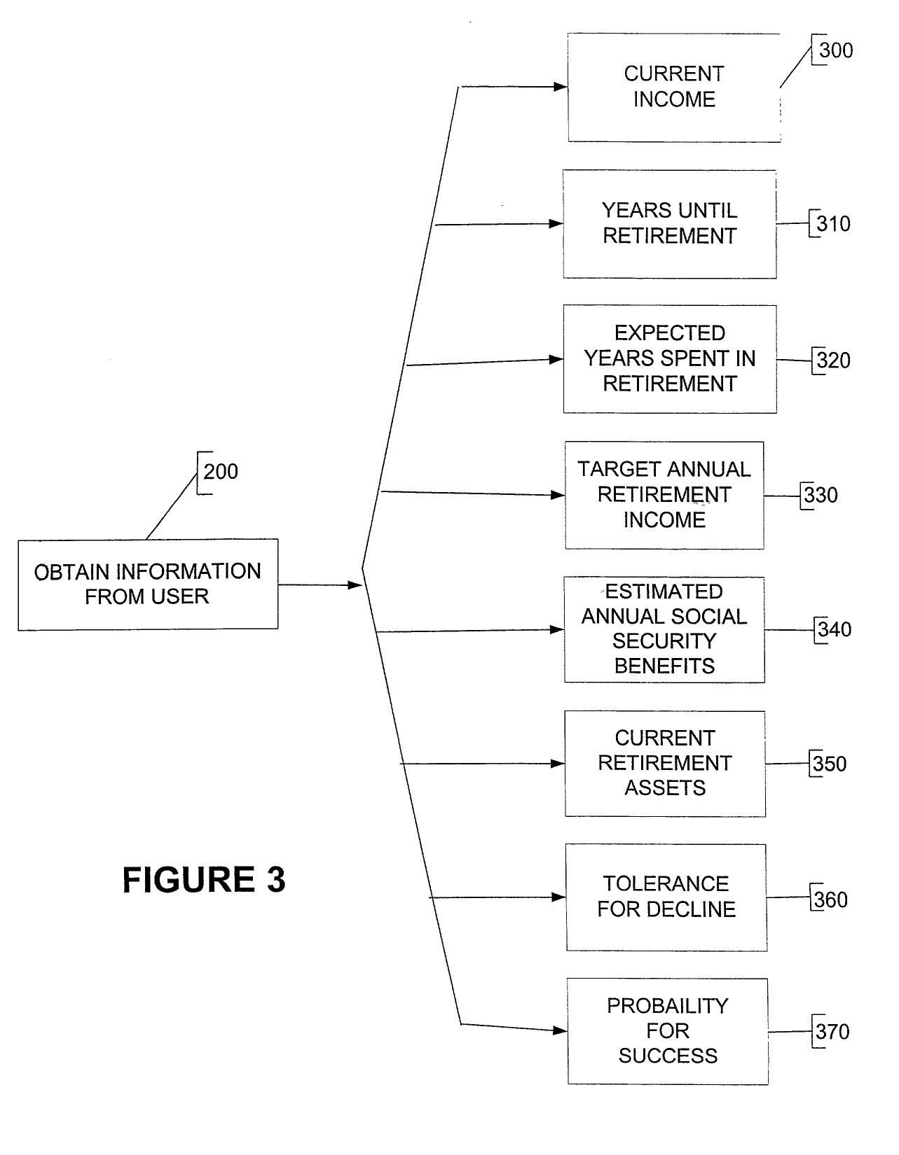

An exemplary embodiment of the process according to the present invention which is capable of determining the asset allocation requirements, return assumptions and/or savings information for the user or users is shown in FIG. 2. In this exemplary embodiment of the process, in step 200, particular information is either obtained from the user device (by the user inputting the information) or retrieved from a storage device (i.e., previously stored information) as described above with reference to FIG. 1. This obtained information is associated with a particular user for whom the arrangement 10 shall determine the asset allocation requirements, return assumptions and/or savings information. This information can be entered in response to Questions A-F described above. FIG. 3 shows an illustration of exemplary information that can be requested from the user. In particular and as described above with respect to Questions A-H, this information may be:

User's Current Income (Block 300),

User's Years Until Retirement (Block 310),

Expected Years to be Spent in Retirement (Block 320),

User's Target Annual Retirement Income (Block 330),

User's Estimated Social Security Benefits (Block 340),

User's Current Retirement Savings/Assets (Block 350),

User's Tolerance for Decline in Assets (Block 360), and

User's Estimated Probability for Success (Block 370).

Historical data for the user and/or other user(s) may also be obtained by the arrangement 10 from its storage device 120 or from a database storing such data (e.g., the database 60).

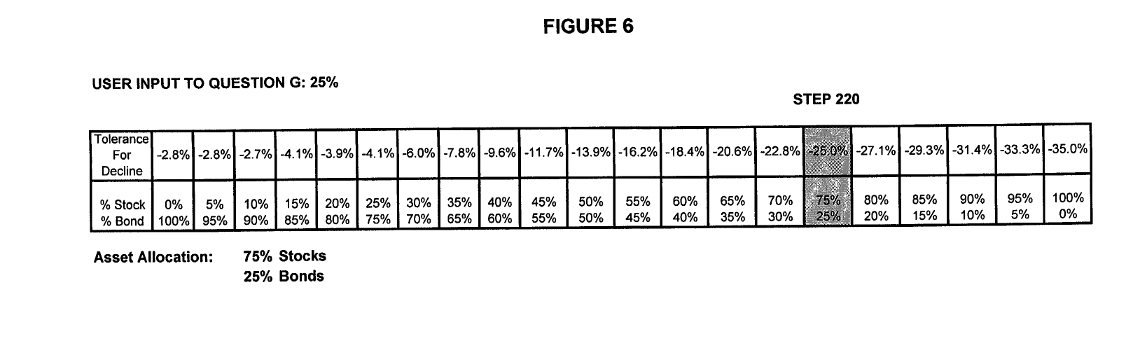

Then, in step 220, the processing device 110 of the arrangement 10 determines the asset allocation for the particular user based on the information obtained in step 200 (and possibly based on the historical data obtained in step 210). This can accomplished by utilizing the information obtained in response to Question G—“What is your tolerance for a decline in your investments or assets (%)?” or block 360. The asset allocation (“AA”) (or the equity asset allocation) is determined by the processing device 110 of the arrangement 10 checking the values in the look-up table, e.g., stored in the storage device 120 and/or obtained from another device or database, such that the TD for the asset allocation does not exceed the user input. An example of such look-up table is shown in FIG. 6. The collection of values for AA (i.e., the asset allocation) may be accumulated based on the historical data obtained in step 210. If, e.g., the user enters 25% as a response to Question G, then AA is determined to be 75% by utilizing the look-up table illustrated in FIG. 6.

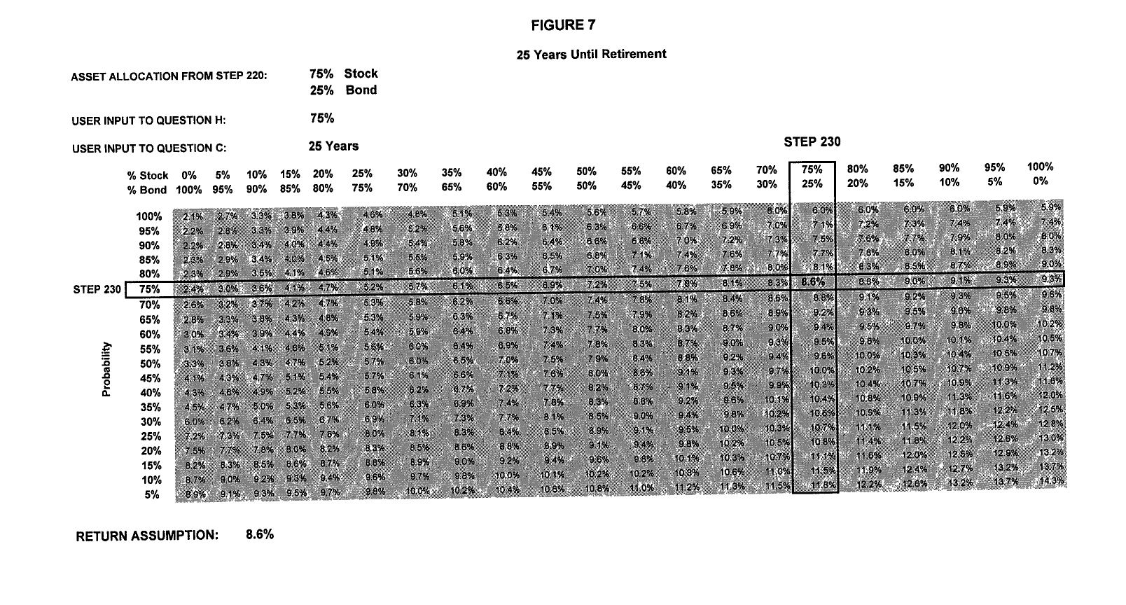

Next, the processing device 110 of the arrangement 10 determines the return assumption (“RA”) for the particular user based on the obtained information (step 230). For example, RA can be determined based on the results obtained for AA in step 220 and using the information input by the user in response to Question H (i.e., “What is your historical probability of success (%)?”) or block 370 and Question C (i.e., “In how many years do you plan to retire?”) or Block 310. Thereafter, the processing device 110 of the arrangement 10 checks the values in the relevant look-up table (determined by the user's input to Question C), e.g., stored in the storage device 120 and/or obtained from another device or database. An example of such look-up table is shown in FIG. 7. The collection of the values for RA (i.e., the return assumption) may be accumulated based on the historical data obtained in step 210. If, e.g., the user enters “75%” as a response to Question H, “25 years” as a response to Question C, and the asset allocation (AA) for this user is determined above to be 75% of equity, then RA is determined to be 8.6% by utilizing the chart illustrated in FIG. 7.

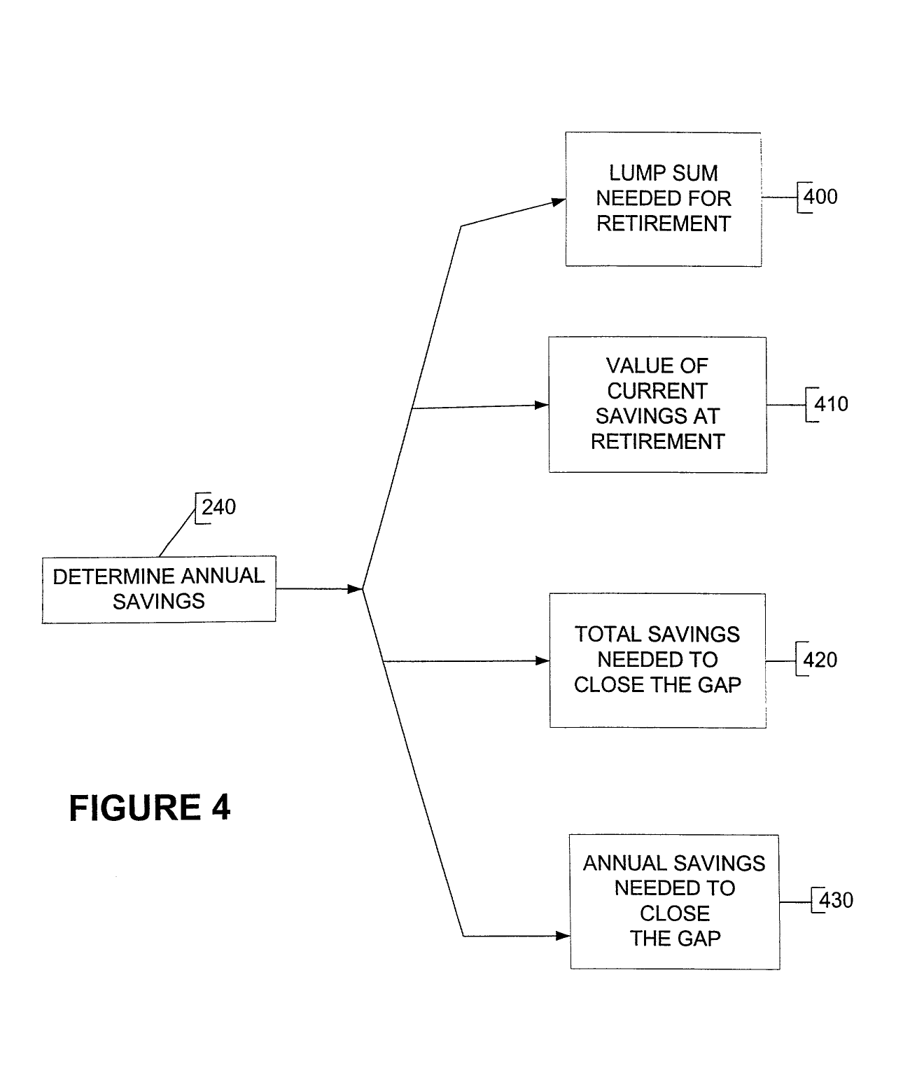

Further, in step 240, the processing device 110 of the arrangement 10 determines the annual savings needed (“AS”) to fund the user's financial goals. This determination is based on the return assumption (RA) calculated in step 240. The exemplary annual savings for the particular user are described in further detail herein below with reference to FIG. 4. In particular, FIG. 4 shows that the annual savings (AS) may include:

Lump sum needed for the user's retirement (block 400),

Value of the user's current savings at the time of retirement (block 410),

Total savings needed for the user to close the gap between the lump sum and the value of the user's savings (block 420), and

Annual savings needed to close the gap (block 430).

According to one embodiment of the present invention, the lump sum (“LS”) needed for the user's retirement (as shown in block 400) is calculated as follows:

$$LS = ( DRI - ESS ) * ( \frac{1 - ( \frac{1}{{( \frac{1 + RA}{1.03} )}^{YIR}} )}{( \frac{1 + RA}{1.03} ) - 1} ) \qquad ( 1 )$$

where DRI is the desired or target annual retirement income (obtained in block 330), ESS is the estimated annual social security income/benefits (obtained in block 340), RA is the return assumption (determined in step 230), and YIR is the expected years spent in retirement (obtained from block 320.

The value of user's estimated current savings at the time of retirement (“ERS”) can be determined according to the following:

$$ERS = CRS * {( \frac{1 + RA}{1.03} )}^{YUR} \qquad ( 2 )$$

where CRS is the current retirement savings/assets (obtained in block 350), and YUR is the expected years until retirement (obtained in block 310).

The total savings (“TS”) needed for the user to close the gap between the lump sum (LS) and the value of the user's estimated current savings (ERS) can be calculated as follows:

TS=LS−ERS (3)

The annual savings (“AS”) needed to close the gap can be determined as follows:

$$AS = ( \frac{TS * ( \frac{1 + RA}{1.03} - 1 )}{{( \frac{1 + RA}{1.03} )}^{YUR} - 1} ) * 1.03 \qquad ( 4 )$$

In this manner, the system, process and financial planning engine according to the present invention is capable of generating the asset allocation, return assumption and annual saving for the user based on the information input by such user.

In an exemplary application of the system, process and financial planning engine according to the present invention, the user may his or her data as follows:

Current Income (in response to Question A, Block 300)—$50,000

Current Retirement Savings/Assets (in response to Question B, Block 330)—$20,000

Years until Retirement (in response to Question C, Block 310)—25 Years

Expected Years in Retirement (in response to Question D, Block 320)—20 Years

Current Retirement Income/Assets (in response to Question E, Block 350)—$40,000

Estimated Annual Social Security (in response to Question F, Block 340)—$10,000

Tolerance for Decline in Investments (in response to Question G, Block 360)—25%

Historical Probability of Success (in response to Question H, Block 370)—75%

Thus, using the above user-provided values, the lump sum (LS) needed for the user's retirement is:

$$LS = ( \$40 , 000 –\$10 , 000 ) * ( \frac{1 - ( \frac{1}{{( \frac{1 + 0.086}{1.03} )}^{20}} )}{( \frac{1 + 0.086}{1.03} ) - 1} ) = \$360 , 396 ,$$

the value of user's estimated current savings at the time of retirement (ERS) is:

$$ERS = \$20 , 000 * {( \frac{1 + 0.086}{1.03} )}^{25} = \$75 , 135 ,$$

the total savings (TS) needed for the user to close the gap between the lump sum (LS) and the value of the user's estimated current savings (ERS) is

TS=$360,396−$75,135=$285,261, and

the annual savings (“AS”) needed to close the gap is:

$$AS = ( \frac{\$285 , 261 * ( \frac{1 + 0.086}{1.03} - 1 )}{{( \frac{1 + 0.086}{1.03} )}^{25} - 1} ) * 1.03 = \$5 , 795$$

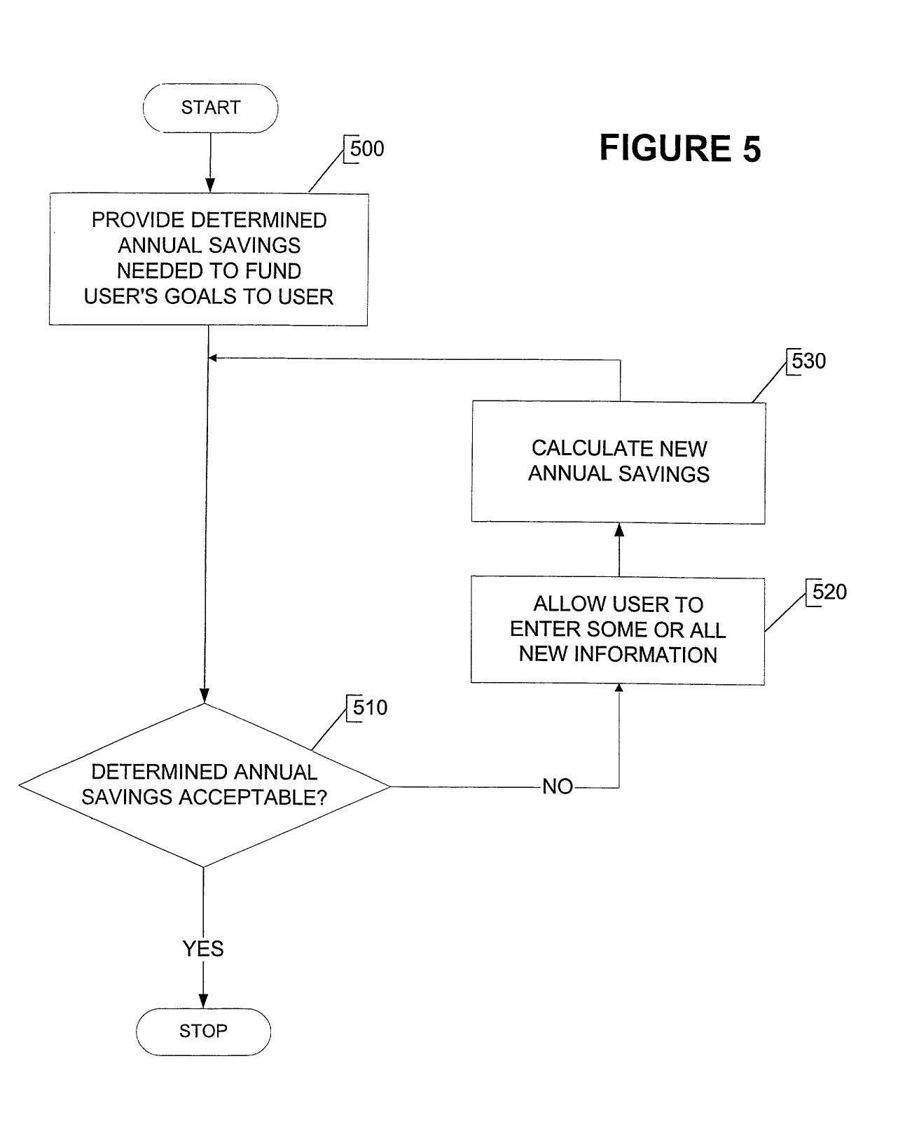

In another embodiment of the system and process of the present invention, a feedback loop is provided for assisting the user to identify and/or modify certain data entered in response to at least one of Questions A through H to change the generated outputs of the system and process. For example, if the user does not accept the annular savings generated by the processing device 10 of the arrangement 10, this embodiment of the system, process and financial planning engine provides a capability for the user to return to the Questions A through H, and allows the user to modify the entered data. For example, the user may modify the length of time that he or she expects to be in retirement. When the data is modified and received by the arrangement 10, the processing device 110 determines new asset allocations, return assumptions and annular savings based on the modified value for the year in retirement. FIG. 5 shows this exemplary embodiment of the process according to the present invention. In particular, the arrangement 10 provides the determined annual savings data to the user (step 500). It is also possible for this data to be stored in the storage device 120, and/or transmitted via the communications network 20 to the database 60 for storage. Then, in step 510, it is determined (e.g., by the user or the processing device 10) if the determined annual savings are acceptable. If not, the user (or processing device 110) modifies some or all of the previously input data in step 520, the new annual savings data are calculated based on the newly input data in step 530, and the process returns to step 510. Otherwise, the process is completed.

It should be appreciated that those skilled in the art will be able to devise numerous systems, methods and processes which, although not explicitly shown or described herein, embody the principles of the invention, and are thus within the spirit and scope of the present invention.

What is claimed is:

1. A process for determining at least one financial indicator for investments and savings to achieve a particular goal, comprising the steps of:
obtaining financial information from an investor;
obtaining further information which is indicative of at least one of:
a. the investor's tolerance for a decline in the investments, and
b. the investor's tolerance for failure to achieve the particular goal; and
determining the at least one financial indicator as a function of the financial information and the further information.

2. The process according to claim 1, wherein the further information is indicative of the investor's tolerance for the decline in the investment.

3. The process according to claim 1, wherein the further information is indicative of the investor's tolerance for failure to achieve the particular goal.

4. The process according to claim 1, wherein the further information includes first and second information, the first information being indicative of the investor's tolerance for the decline in the investment, the second information being indicative of the investor's tolerance for failure to achieve the particular goal.

5. The process according to claim 4, wherein the at least one financial indicator is determined as a function of the particular information, the first information and the second information.

6. The process according to claim 1, wherein the at least one financial indicator includes asset allocation data for the investor.

7. The process according to claim 6, wherein the determining step includes the substep of calculating the asset allocation data based on the financial information.

8. The process according to claim 7, further comprising the step of:
obtaining historical data for the investor or for at least one further party, wherein the asset allocation data is calculated using the historical data.

9. The process according to claim 6, wherein the at least one financial indicator includes return assumption data for the investor.

10. The process according to claim 9, wherein the determining step includes the substep of calculating the return assumption data based on the asset allocation data and the financial information.

11. The process according to claim 6, wherein the at least one financial indicator include annual savings data for the investor.

12. The process according to claim 11, wherein the annual saving data includes at least one of:
a. first data indicative of a lump sum needed for a retirement of the investor,
b. second data indicative of a value of current savings at the retirement of the investor,
c. third data indicative of total savings needed to close a gap for the investor between the first data and the second data, and
d. fourth data indicative of annual savings needed to close the gap.

13. The process according to claim 1, wherein the financial information includes at least one of:
a. current income of the investor,
b. expected years until retirement of the investor,
c. expected years to be spent in retirement,
d. target annual retirement income of the investor,
e. estimated annual social security benefits of the investor, and
f. current retirement assets of the investor.

14. The process according to claim 13, wherein the at least one financial indicator includes return assumption data for the investor and lump sum data for the retirement of the investor, and wherein the lump sum data are calculated based on:
the estimated annual social security benefits,
the expected years to be spent in the retirement, and
the return assumption data.

15. The process according to claim 13, wherein the at least one financial indicator includes return assumption data for the investor and current value of savings data at the retirement of the investor, and wherein the current value of savings data are calculated based on:
the current retirement assets of the investor,
the expected years until the retirement of the investor, and
the return assumption data.

16. The process according to claim 15, wherein the at least one financial indicator includes return assumption data for the investor and annual current saving data need for the retirement of the investor, and wherein the current savings data are calculated based on:
the current value of savings data,
the expected years until the retirement of the investor, and
the return assumption data.

17. The process according to claim 1, further comprising the steps of:
determining if the at least one financial indicator is acceptable;
if the at least one financial indicator is not acceptable, receiving additional financial information which includes at least one portion which is different from at least one portion of the obtained financial information; and
determining the at least one financial indicator as a function of the received additional financial information and the further information.

18. A system for determining at least one financial indicator for investments and savings to achieve a particular goal, comprising:
a processing arrangement which:
obtains financial information from an investor;
obtains further information which is indicative of at least one of:
a. the investor's tolerance for a decline in the investments, and
b. the investor's tolerance for failure to achieve the particular goal, and
determines the at least one financial indicator as a function of the financial information and the further information.

19. The system according to claim 18, wherein the further information is indicative of the investor's tolerance for the decline in the investment.

20. The system according to claim 18, wherein the further information is indicative of the investor's tolerance for failure to achieve the particular goal.

21. The system according to claim 18, wherein the further information includes first and second information, the first information being indicative of the investor's tolerance for the decline in the investment, the second information being indicative of the investor's tolerance for failure to achieve the particular goal.

22. The system according to claim 21, wherein the processing arrangement determines the at least one financial indicator as a function of the particular information, the first information and the second information.

23. The system according to claim 18, wherein the at least one financial indicator includes asset allocation data for the investor.

24. The system according to claim 23, wherein the processing arrangement determines the at least financial indicator by calculating the asset allocation data based on the financial information.

25. The system according to claim 24, wherein the processing arrangement obtains historical data for the investor or for at least one further party, and calculates the asset allocation data using the historical data.

26. The system according to claim 23, wherein the at least one financial indicator includes return assumption data for the investor.

27. The system according to claim 26, wherein the processing arrangement determines the at least financial indicator by calculating the return assumption data based on the asset allocation data and the financial information.

28. The system according to claim 23, wherein the at least one financial indicator include annual savings data for the investor.

29. The system according to claim 28, wherein the annual saving data includes at least one of:
a. first data indicative of a lump sum needed for a retirement of the investor,
b. second data indicative of a value of current savings at the retirement of the investor,
c. third data indicative of total savings needed to close a gap for the investor between the first data and the second data, and
d. fourth data indicative of annual savings needed to close the gap.

30. The system according to claim 18, wherein the financial information includes at least one of:
a. current income of the investor,
b. expected years until retirement of the investor,
c. expected years to be spent in retirement,
d. target annual retirement income of the investor,
e. estimated annual social security benefits of the investor, and
f. current retirement assets of the investor.

31. The system according to claim 30, wherein the at least one financial indicator includes return assumption data for the investor and lump sum data for the retirement of the investor, and wherein the processing arrangement calculates the lump sum data based on:
the estimated annual social security benefits,
the expected years to be spent in the retirement, and
the return assumption data.

32. The system according to claim 30, wherein the at least one financial indicator includes return assumption data for the investor and current value of savings data at the retirement of the investor, and wherein the processing arrangement calculates the current value of savings data based on:
the current retirement assets of the investor,
the expected years until the retirement of the investor, and
the return assumption data.

33. The system according to claim 32, wherein the at least one financial indicator includes return assumption data for the investor and annual current saving data need for the retirement of the investor, and wherein the processing arrangement calculates the current savings data based on:
the current value of savings data,
the expected years until the retirement of the investor, and
the return assumption data.

34. The system according to claim 1, wherein the processing arrangement:
determines if the at least one financial indicator is acceptable,
if the at least one financial indicator is not acceptable, receives additional financial information which includes at least one portion which is different from at least one portion of the obtained financial information, and
determines the at least one financial indicator as a function of the received additional financial information and the further information.

35. A financial planning engine for determining at least one financial indicator for investments and savings to achieve a particular goal, comprising:
at least one software module which is capable of being executed by a processing device to:
obtain financial information from an investor,
obtain further information which is indicative of at least one of:
a. the investor's tolerance for a decline in the investments, and
b. the investor's tolerance for failure to achieve the particular goal, and
determine the at least one financial indicator as a function of the financial information and the further information.
